(19) United States
(12) Patent Application Publication
(10) Pub. No.: US 2017/0140750 A1
(43) Pub. Date: May 18, 2017

(54) METHOD AND DEVICE FOR SPEECH RECOGNITION

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Yujun WANG, Tianjin (CN); Hengyi ZHAO, Tianjin (CN)

(21) Appl. No.: 15/245,096

(22) Filed: Aug. 23, 2016

Related U.S. Application Data
(63) Continuation of application No. PCT/CN2016/089096, filed on Jul. 7, 2016.

(30) Foreign Application Priority Data
Nov. 17, 2015 (CN) 201510790077.8

(51) Int. Cl. G10L 15/02; G10L 25/87; G10L 15/07; G10L 17/06; G10L 15/22; G10L 25/21; G10L 15/18

(52) U.S. Cl. CPC G10L 15/02; G10L 25/21; G10L 25/87; G10L 15/1815; G10L 17/06; G10L 15/22; G10L 15/07; G10L 2025/783

(57) ABSTRACT

An embodiment of the present disclosure discloses a method and a system for speech recognition. The method comprises steps of intercepting a first speech segment from a monitored speech signal, analyzing the first speech segment to determine an energy spectrum; extracting characteristics of the first speech segment according to the energy spectrum, determining speech characteristics; analyzing the energy spectrum of the first speech segment according to the speech characteristics, intercepting a second speech segment; recognizing the speech of the second speech segment, and obtaining a speech recognition result. The method solves the problems of single recognition function and low recognition rate of the prior art in the off-line state.

### CROSS-REFERENCE TO RELATED APPLICATIONS

This application is a continuation of International Application No. PCT/CN2016/089096 filed on Jul. 7, 2016, which is based upon and claims priority to Chinese Patent Application No. 201510790077.8, entitled “METHOD AND SYSTEM FOR SPEECH RECOGNITION”, filed on Nov. 17, 2015 to the State Intellectual Property Office, the entire contents of all of which are incorporated herein by reference.

### TECHNICAL FIELD

The present disclosure generally relates to speech detection field, in particular to a method for speech recognition and a system for speech recognition.

### BACKGROUND

At present, during electronic product development in the fields of Telecommunications and service industries and industrial production lines, speech recognition technology has been applied to many electronic products, and a batch of novel speech products have been created, for example, speech textbooks, acoustic control tools, speech remote controllers, and household service machines, thus greatly reducing labor intensity, improving working efficiency and increasingly changing people's daily life. At present, speech recognition technology is regarded as one of the most challenging application technologies with the biggest market prospects.

Along with the development of the speech recognition technology, huge increase of the speech data quantity, iteration of the calculation resources and capabilities, and dramatic rise of the wireless connection speed, cloud service of speech recognition has become a mainstream product and application of the speech technology. Users submit speeches to a server of a speech cloud for processing through own terminal devices; processing results are fed back to the terminals; and the terminals display corresponding recognition results or execute corresponding command operations.

However, during implementing the present disclosure, the inventor found the speech recognition technology in the prior art still has some defects. For example, in the case of no wireless connection, namely in the off-line state, users cannot upload speech segments to the cloud server for processing, resulting in failure to obtain accurate recognition results because the speech recognition proceeds without the support of the cloud server. For another example, in the off-line state, the initial position of the speech signal cannot be accurately determined, only single words or phrases can be recognized, and the recognition rate is reduced due to compression of the speech signal during the speech recognition.

Therefore, the problem to be urgently solved by those skilled in this field is to provide a method and a system for speech recognition. The method and the system solve the problems of single recognition function and low recognition efficiency in the off-line state in the prior art.

### SUMMARY

An embodiment of the present disclosure discloses a method and a device for speech recognition for solving problems of single recognition function and low recognition efficiency in the off-line state in the prior art.

According to one aspect of the present disclosure, an embodiment of the present disclosure discloses a method for speech recognition, including: intercepting a first speech segment from a monitored speech signal, and analyzing the first speech segment to determine an energy spectrum extracting characteristics of the first speech segment according to the energy spectrum, and determining speech characteristics; analyzing the energy spectrum of the first speech segment according to the speech characteristics, and intercepting a second speech segment; recognizing the speech of the second speech segment, and obtaining a speech recognition result.

Correspondingly, according to another aspect of the present disclosure, an embodiment of the present disclosure discloses an electronic device for speech recognition, including at least one processor, and a memory communicably connected with the at least one processor for storing instructions executable by the at least one processor, wherein execution of the instructions by the at least one processor causes the at least one processor to: intercept a first speech segment from a monitored speech signal and analyze the first speech segment to determine an energy spectrum, extract characteristics of the first speech segment according to the energy spectrum and determine speech characteristics; analyze the energy spectrum of the first speech segment according to the speech characteristics, and intercept a second speech segment; and recognize the speech of the second speech segment and obtaining a speech recognition result.

According to another aspect of the present disclosure, the present discloses a computer program, including computer readable codes, wherein the computer readable codes operate on a smart TV such that the smart TV executes the method for speech recognition.

According to another aspect of the present disclosure, an embodiment of the present disclosure discloses a non-transitory computer readable medium storing executable instructions that, when executed by an electronic device, cause the electronic device to: intercept a first speech segment from a monitored speech signal, analyze the first speech segment to determine an energy spectrum; extract characteristics of the first speech segment according to the energy spectrum, determine speech characteristics; analyze the energy spectrum of the first speech segment according to the speech characteristics, intercept a second speech segment; and recognize the speech of the second speech segment and obtain a speech recognition result.

The present disclosure has the following beneficial effects:

according to the method and system for speech recognition according to the embodiments of the present disclosure, the terminal monitors the speech signal, intercepts a first speech segment from a monitored speech signal analyzes the first speech segment to determine the energy spectrum, extracts characteristics of the first segment of speech signal according to the energy spectrum, intercepts the first speech segment according to the extracted speech characteristics to obtain more accurate second speech segment, perform speech recognition on the second speech segment to obtain the speech recognition result, and performs semantic analysis according to the speech recognition result. The terminal directly processes the speech signal instead of uploading the speech signal to the server to recognize the speech, acquires the speech recognition result, and directly recognizes the energy spectrum of the speech, thus improving the speech recognition rate.

The above description is a summary of the solution of the present disclosure. In order to more clearly describe the technical means of the present disclosure, the content of the description can be executed. Moreover, in order to ensure that the above and other objectives, characteristics and advantages of the present disclosure more understandable, embodiments of the present disclosure are described below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow chart of a method for speech recognition in accordance with some embodiments.

FIG. 2 is a step flow chart of a method for speech recognition in accordance with some embodiments.

FIG. 3 is a structural block diagram of an acoustic model of the method for speech recognition in accordance with some embodiments.

FIG. 4 is a structural block diagram of a system for speech recognition in accordance with some embodiments.

FIG. 5 is a structural block diagram of a system for speech recognition in accordance with some embodiments.

FIG. 6 schematically illustrates a block diagram of an electronic device for executing the method in accordance with some embodiments.

FIG. 7 schematically illustrates a memory cell for holding or carrying program codes for realizing the method in accordance with some embodiments.

### DETAILED DESCRIPTION

To make the objectives, technical solutions and advantage of the embodiments of the present disclosure more clear, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field can obtain other embodiments without creative labor, which all shall fall within the protection scope of the present disclosure.

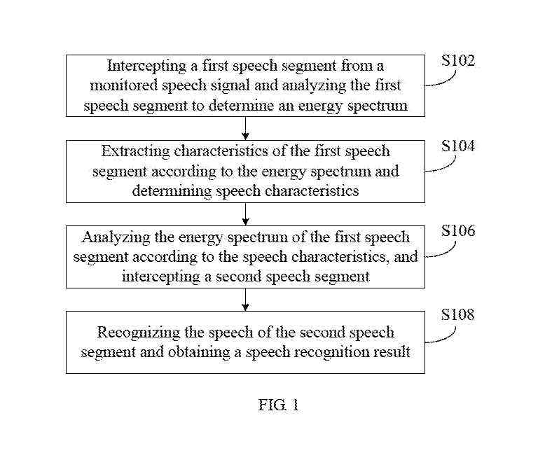

Refer to FIG. 1, which illustrates a step flow chart of a method for speech recognition according to one embodiment of the present disclosure. The method specifically may include the following steps.

Step S102: intercept a first speech segment from a monitored speech signal, analyze the first speech segment to determine an energy spectrum.

Existing speech identification usually executed in a way that: the terminal uploads the speech data to a server of the network side and the server recognizes the uploaded speech data. However, the terminal may sometimes be in environment without network and therefore cannot upload the speech to the server. This embodiment supplies an off-line speech recognition method, capable of effectively using local resources to perform off-line speech recognition.

First, the terminal monitors the speech signal sent by the user, intercepts the speech signal according to an adjustable energy threshold scope to obtain the speech signals out of the threshold scope. Second, the terminal takes the intercepted speech signal as the first speech segment.

Wherein the first speech segment is used for extracting speech data to be recognized. In order to ensure that the speech portion capable of being effectively recognized is acquired, the first speech segment can be cut in a fuzzy mode, which means that the interception scope is enlarged when the first speech segment is cut, for example the interception scope of the speech signal to be recognized is enlarged to ensure that all effective speech segments fall within the first speech segment. Then, the first speech segment includes effective speech segments and ineffective speech segments, for example, silent and noise portions.

Then, the first speech segment undergoes the time-frequency analysis and is converted into the energy spectrum corresponding to the first speech segment, wherein the time-frequency analysis includes steps of converting the time-domain wave signal of the speech signal corresponding to the first speech segment into the frequency-domain wave signal and removing the phase information in the frequency-domain wave signal to obtain the energy spectrum The energy spectrum is used for extraction of the subsequent speech characteristics and other processing of the speech recognition.

Step S104: extract characteristics of the first speech segment according to the energy spectrum and determine speech characteristics.

Characteristic extraction is carried out on the speech signal corresponding to the first speech segment according to the energy spectrum to obtain speech characteristics including speech recognition characteristics, speaker speech characteristics and base frequency characteristics, etc.

Wherein, the speech characteristics can be extracted in many ways, for example, the speech signal of the first speech segment passes a preset module to extract the speech characteristic coefficient, thus determining the characteristics.

Step S106: analyze the energy spectrum of the first speech segment according to the speech characteristics, and cut a second speech segment.

The speech signals corresponding the first speech segment are tested in turn according to the above extracted speech characteristics. During interception of the first speech segment, the preset interception scope is relatively large to ensure all effective speech segments fall within the first speech segment, so the first speech segment includes effective speech segments and ineffective speech segments. In order to improve the speech recognition efficiency, the first speech segment can be cut again to remove the ineffective speech segments, thus accurately extracting the effective speech segments as the second speech segment.

The speech recognition in the prior art is usually executed on single words or phrases. The embodiment of the present disclosure can completely recognize the speech of the second speech segment and subsequently execute all operations required for the speech.

Step S108: recognize the speech of the second speech segment and obtain a speech recognition result.

Speech recognition is executed on the speech signal corresponding to the second speech segment according to the extract speech characteristics, for example, the Hidden Markov Model is adopted to perform speech recognition to obtain the speech recognition result, and the speech recognition result is segment of speech text, including all information of the second speech segment.

If the speech recognition result of the speech signal corresponding to the second speech segment is a passage; the passage is divided into one or more operation steps; semantic analysis is carried out according to the speech recognition result to obtain the operation steps, and the corresponding operation steps are executed. Thus, the problem of single speech recognition is solved. Through detailing of the operation steps, the recognition rate is also enhanced.

In conclusion, according to the above embodiment of the present disclosure, the terminal monitors the speech signal, intercepts a first speech segment from a monitored speech signal, analyzes the first speech segment to determine the energy spectrum, extracts characteristics of the first segment of speech signal according to the energy spectrum, intercepts the first speech segment according to the extracted speech characteristics to obtain more accurate second speech segment, and perform speech recognition on the second speech segment to obtain the speech recognition result. The terminal directly processes the monitored speech signal instead of uploading the speech signal to the server to recognize the speech, acquires the speech recognition result, and directly recognizes the energy spectrum of the speech, thus improving the speech recognition rate.

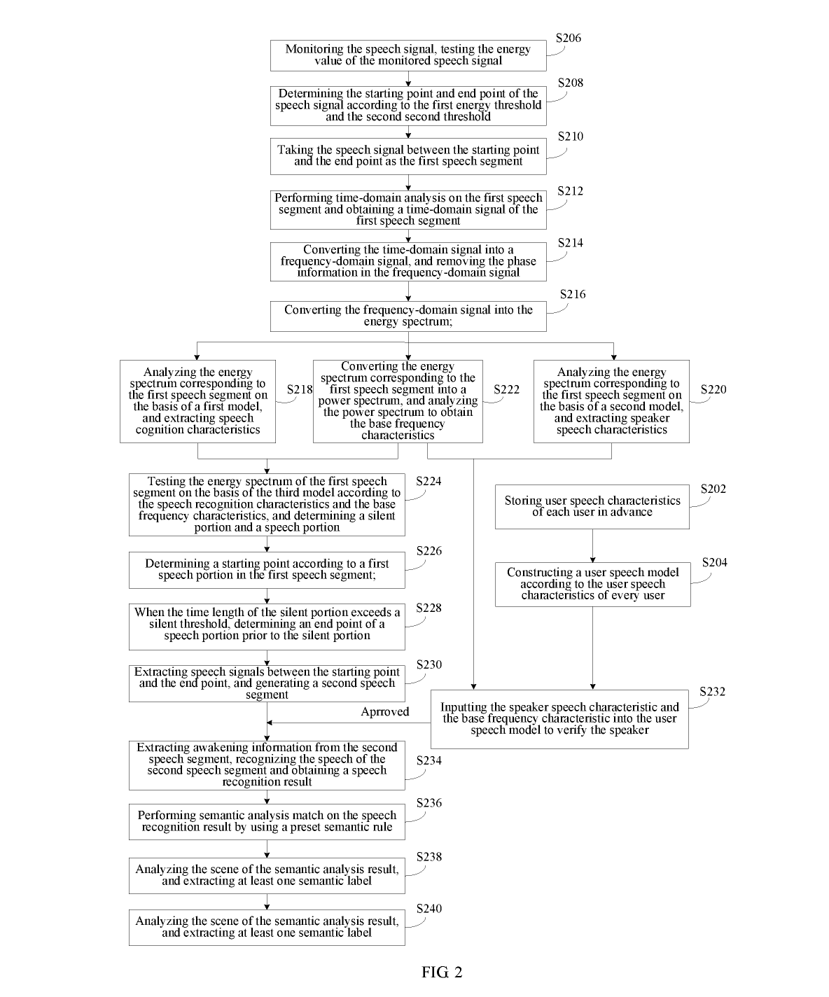

Refer to FIG. 2, which illustrates a step flow chart of a data recoding method according to another embodiment of the present disclosure. The method may specifically include the following steps.

Step S202: store user speech characteristics of each user in advance.

Step S204: construct a speaker speech model according to the user speech characteristics of every user.

Before the speech recognition, the speech characteristics of each user are pre-recorded; the speech characteristics of every user are combined to form a complete user characteristic; every complete user characteristic is stored while the personal information of every user is marked; the complete characteristics and personal information identifiers of all users are combined to form a user speech model, wherein the user speech module is used for speaker verification.

Wherein, the pre-recorded speech characteristics of each user includes: tone characteristics, pitch contours, resonance peaks and bandwidths as well as speech intensity of the vowel signal, voiced sound signal and speechless consonant signal, of the user.

Step S206: monitor the speech signal and test the energy value of the monitored speech signal.

The terminal device monitors the speech signal recorded by the user, determines the energy value of the speech signal, tests the energy value, and intercepts the subsequent signal according to the energy value.

Step S208: Determine the starting point and end point of the speech signal according to the first energy threshold and the second threshold.

A first energy threshold and a second energy threshold are preset, wherein the first energy threshold is greater than the second energy threshold; the first signal point of a speech signal of which the energy value is N times greater than the first energy threshold is taken as the starting point of the speech signal; after the starting point is determined, the first signal of a speech signal of which the energy value is M times smaller than the second energy threshold is taken as the end point, wherein M and N can be adjusted according to the energy value of the speech signal sent by a user.

Wherein, time setting can be executed upon actual demands; a first time threshold is set; when the energy of a speech signal exceeds a first time threshold of the first energy threshold, it is deemed that the speech signal prior to the first time threshold enters a speech portion, similarly, when the energy value of a speech signal is smaller than a first time threshold of the second energy threshold, it is deemed that the speech signal prior to the first time threshold enters a non-speech portion.

For example, the root-mean-square energy of a time-domain signal is taken as a determination basis, and the root-mean-square energy of initial speech and non-speech signals is preset. When the root-mean-square energy of a signal continuously exceeds the non-speech signal energy by a plurality of decibels (usually 10 db) for a period of time (for example 60 ms), it is regarded that the signal enters the speech portion before 60 ms; similarly, when the root-mean-square energy of a signal is continuously lower than the energy of the speech signal by a plurality of decibels (usually 10 db) for a period of time (for example 60 ms), it is regarded that the signal enters the non-speech portion before 60 ms, wherein the root-mean-square energy of the initial speech signal is the first energy threshold, and the root-mean-square energy of the non-speech signal is the second energy threshold.

Step S210: Take the speech signal between the starting point and end point as the first speech segment.

According to the determined starting point and end point of a speech signal, the speech signal between the starting point and the end point is taken as the first speech segment, wherein the first speech segment serving as an effective speech segment is used for subsequent processing of the speech signal.

Step S202: perform time-domain analysis on the first speech segment and obtain a time-domain signal of the first speech segment.

Step S214: convert the time-domain signal into a frequency-domain signal, and remove the phase information in the frequency-domain signal.

Step S216: convert the frequency-domain signal into the energy spectrum.

The first speech segment undergoes the time-frequency analysis; the speech signal corresponding to the first speech segment is converted into a time-domain signal to obtain the time-domain signal of the speech signal corresponding to the first speech segment; the time-domain signal of the speech signal corresponding to the first speech segment is converted into a frequency-domain signal, and the frequency-domain signal is converted into the energy spectrum, wherein the time-domain analysis includes the steps of converting the time-domain signal of the speech signal corresponding to the first speech segment into the frequency-domain signal, and removing the phase information of the frequency-domain signal to obtain the energy spectrum.

An optimal solution according to the embodiment of the present disclosure can convert the time-domain signal into the frequency-domain signal through Fast Fourier Transformation.

Step S218: analyze the energy spectrum corresponding to the first speech segment on the basis of a first model, and extract speech cognition characteristics.

The energy spectrum corresponding to the first speech segment passes the first model in turn to extract speech recognition characteristics, wherein the speech recognition characteristics include: MFCC (Mel Frequency Cepstral Coefficient) characteristic, PLP (Perceptual Linear Predictive) characteristic, or LDA (Linear Discriminant Analysis) characteristic.

Mel is the unit of the subjective frequency, and Hz is the unit of the objective pitch. Mel frequency is proposed on the basis of human auditory characteristics, which is in a nonlinear correspondence relationship with the Hz frequency. MFCC is the Hz spectrum characteristic obtained through calculation by using the above mentioned relationship.

Speech information is mostly concentrated in the low-frequency portion, while the high-frequency portion tends to be interfered by environmental noises. FCC (Predictive Cepstral Coefficient) converts the linear frequency scale into Mel frequency scale, highlighting the low-frequency information of a speech. Therefore, except having the advantages of LPPC (Linear Predictive Cepstral Coefficient), FCC also highlights information favorable for recognition, and shields noise interference.

MFCC has no any presumption and hypothesis and can be used in all circumstances. The LPCC assumes that the processed signal is an AR signal, but this hypothesis is not established in a strict sense for a consonant with a strong dynamic characteristic, so the MFCC is prior to LPCC. FFT (Fast Fourier Transformation) is needed during the MFCC extraction process, so all information in the frequency domain of the speech signal can be obtained.

Step S220: analyze the energy spectrum corresponding to the first speech segment on the basis of a second model, and extract speaker speech characteristics.

The energy spectrum corresponding to the first speech segment passes the second model in turn, and the speaker speech characteristic is extracted according to the second speech segment, wherein the speaker speech characteristic includes the high-order MFCC characteristic.

For example, the previous and next frames of the MFCC are brought into the differential operation to obtain a high-order MFCC, and the high-order MFCC is taken as the speaker speech characteristic.

The speaker speech characteristic is used for verifying the user, to which the second speech segment belongs.

Step S222: convert the energy spectrum corresponding to the first speech segment into a power spectrum, and analyze the power spectrum to obtain the base frequency characteristics.

The energy spectrum corresponding to the first speech segment is analyzed. For example, the speech signal corresponding to the first speech segment is applied to the power spectrum through FFT or DCT (Discrete Cosine Transform); characteristic extraction is carried out, and then the base frequency or tone of a speaker appears in form of a peak values in the high-order portion of the analysis result. The peak values are traced through dynamic programming along the time axis, and then it is known that whether the speech signal has a base frequency and a base frequency value.

Wherein, the base frequency characteristic includes the tone characteristics of the vowel signal, voiced sound signal and speechless consonant signal.

The base frequency reflects vocal cord vibration and tone and can assist secondary interception and speaker verification.

Step S224: test the energy spectrum of the first speech segment on the basis of the third model according to the speech recognition characteristics and base frequency characteristics, and determine a silent portion and a speech portion.

Step S226: determine a starting point according to a first speech portion in the first speech segment.

Step S228: when the time length of the silent portion exceeds a silent threshold, determine an end point of a speech portion prior to the silent portion.

Step S230: extract speech signals between the starting point and the end point, and generate a second speech segment.

The speech signals corresponding to the first speech segment pass the third model in turn according to the MFCC characteristic in the speech recognition characteristic and the tone characteristic of the user in the base frequency characteristic, and the silent portion and the speech portion of the first speech segment are tested, wherein the third model includes, but not limited to HMM (Hidden Markov Model).

The third model has two preset states, namely silent state and speech state. The speech signals corresponding to the first speech segment pass the third model in turn, all signal points of a speech signal corresponding to the first speech segment are continuously switched between the two states in turn until it is determined the points enter the silent state or the speech state, and then the speech portion and the silent portion of the speech signal can be determined.

The starting point and the end point of the speech portion are determined according to the silent portion and the speech portion of the first speech segment, and the speech portion is extracted as the second speech segment, wherein the second speech segment is used for subsequent speech recognition.

Wherein, the majority of the non-specific human speech recognition systems with a large vocabulary and continuous speeches are HMM-based models. HMM establishes a statistics model for the time sequence structure of a speech signal. The statistics model is regarded as a mathematically dual random process: one random process is an implicated process which uses a Markov chain with a finite state number to simulate changes in the statistics characteristics of a speech signal, and the other random process is associated with every state of the Markov chain and is used for observing sequence. The former is reflected by the latter, but the specific parameters of the former are immeasurable. A speech process of a person is actually a dual random process. The speech signal itself is an observable time-variable sequence and is a parameter stream of phonemes sent by the brain according to the grammar and the speech needs (unobservable state). HMM rationally simulates the process, well describes the overall non-stability and partial stability of the speech signal, and therefore is an ideal speech model.

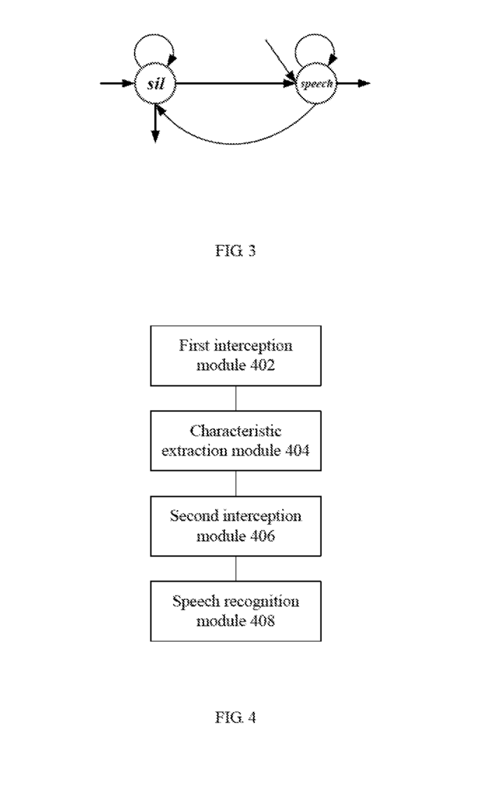

For example, refer to FIG. 3. The HMM model has two states, sil and speech. The two states respectively correspond to the silent (non-speech) portion and the speech portion. The test system starts from the sil state and then is continuously switched between those two states until in a certain period of time (for example 200 ms) the system keeps being in the sil state, which represents that the system tests the silent state. Tracing back to the history of the state switching from this period of time, the starting point and the end point of the speech in the history can be known.

Step S232: Input the speaker speech characteristic and the base frequency characteristic into the user speech model to verify the speaker.

Characteristic parameters corresponding to the speech characteristic of the speaker such as the high-order MFCC characteristic and the base frequency characteristics such as the tone characteristics of the vowel signal, voiced sound signal and speechless consonant signal are input into the user speech model in turn. The user model matches the above characteristics with the pre-stored speech characteristics of each user to obtain an optimal match result, and then determines the speaker.

According to an optimal solution of the embodiment of the present disclosure, user match can be carried out by determining whether a posterior probability or a confidence coefficient is greater than a threshold.

Step S234: When the speaker passes the verification, extract awakening information from the second speech segment, recognize the speech of the second speech segment and obtain a speech recognition result.

After the speaker passes the verification, the subsequent series of speech recognition steps are continuously executed to recognize the speech in the second speech segment and obtain a speech recognition result, wherein the speech recognition result includes the awakening information, and the awakening information includes awakening words or awakening intention information.

In the process of recognizing the speech of the second speech segment, a data dictionary can be used for assisting the speech recognition, for example, fuzzy match for speech recognition can be executed through the local data and network data stored in the data dictionary to quickly obtain the recognition result.

The awakening words can include preset phrases, for example, “show the contact list”: the awakening intention information can include: words or sentences with obvious operational intentions in the recognition result, for example: “Play the third episode of The Legend of Zhen Huan”.

An awakening step is preset; the system tests the recognition results; when testing that the recognition result includes the awakening information, the system enables the awakening step and performs interaction mode.

Step S236: Perform semantic analysis match on the speech recognition result by using a preset semantic rule.

Step S238: Analyze the scene of the semantic analysis result, and extract at least one semantic label.

Step S240: Determine an operation command according to the semantic label and execute the operation command.

Semantic analysis match is executed on the speech recognition result by using the preset semantic rule, wherein the preset semantic rule can include BNF grammar; and the semantic analysis match mainly include at least one of the following: precise match, semantic element match and fuzzy match. The three match modes can be matched in sequence, for example, if the speech recognition result has been completely analyzed through the precise match, the subsequent matches are not needed; for another example, if only 80% of the speech recognition result is obtained through the precise match, the subsequent semantic element match and/or fuzzy match is needed.

Precise match refers to completely precise match of the speech recognition result, for example “calling the contact list”, the operation command for calling the contact list can be directly analyzed through the precise match.

Semantic element match refers to a process of extracting semantic elements from a speech recognition result and performing match through the extracted semantic elements, for example: the semantic elements mentioned in the sentence “Play the third episode of The Legend of Zhen Huan” include “play”, “The Legend of Zhen Huan” and “the third episode”, the speech elements are matched and operation commands are executed in turn according to the match result.

Fuzzy match refers to fuzzy match of the unclear speech recognition results, for example, the recognition result is “Call the contact Chen Qi in the contact list”, but the contact list only has Chen Ji, and not Chen Qi; then, through the fuzzy match, Chen Qi in the recognition result is replaced by Chen Ji, and then the operation command is executed.

The scene of the semantic analysis result is analyzed through the data directory. The recognition result is placed in a corresponding specific scene; in the specific scene, at least one speech label is extracted; the speech label is converted in format, wherein the data dictionary includes local data and network data, and the format conversion includes conversion into data in JSON format.

The data dictionary is essentially a data packet, storing local data and network data. In the process of speech recognition and semantic analysis, the data dictionary supports the speech recognition of the second speech segment and the semantic analysis of the speech recognition result.

In the case of having local connection, a local system can send some insensitive user favorite data into a cloud sever. The cloud server adds titles of new relevant high-frequency videos and names of songs to the dictionary according to the data uploaded by the user and with reference to the big-data-based recommendation of the cloud, and delete the low-frequency terms, and then pushes the results back to the local terminal. Besides, some local dictionaries, such as contact list, are usually added. Those dictionaries can be hot-updated without rebooting the recognition server, thus continuously improving the speech recognition rate and the analysis successful rate.

The corresponding operation command is determined according to the converted data, and actions to be executed are executed according to the operation command.

For example, if the recognition result is “Play the Legend of Zhen Huan”, and through analysis, the intention is “TV series”. The intention “TV series” includes three key semantic labels:

1. Operation: “play”;

2. Title of the TV series: “The Legend of Zhen Huan”;

3. Episode No.: unspecified.

Here “unspecified” is a value agreed with the application layer developer, meaning “not set”.

The above semantic labels are used to perform format conversion on the recognition result; a bottom interface is called according to data obtained after the conversion to execute an operation, for example: call an audio play program to search “The Legend of Zhen Huan” according to the semantic labels and play “The Legend of Zhen Huan” according to the episode number on the label.

According to the above embodiment of the present disclosure, the terminal monitors the speech signal intercepts the first speech segment from the monitored speech signal, analyzes the first speech segment to determine the energy spectrum, extracts characteristics of the first segment of speech signal according to the energy spectrum, namely extracts the speech recognition characteristic, speaker characteristic and base frequency characteristic respectively, intercepts the first speech segment according to the speech recognition characteristic and the base frequency characteristic to obtain more accurate second speech segment, determines the user, to which the speech segment belongs according to the speaker speech characteristic and the base frequency characteristic, presets the awakening step, performs speech recognition on the second speech segment and obtains the speech recognition result. The terminal directly processes the speech signal instead of uploading the speech signal to the server to recognize the speech, acquires the speech recognition result, and directly recognizes the energy spectrum of the speech, thus improving the speech recognition rate.

It is needed to be noted that, for simple description, the method embodiments are described as a series of action combinations, but those skilled in this field should understand that the embodiments of the present disclosure are not limited by the sequence of the described actions because according to the embodiments of the present disclosure, some steps can be implemented in other sequence or at the same time. Moreover, those skilled in this field also should understand that the embodiments described in the present disclosure all belong to optimal embodiments, and some actions involved are not always needed by the embodiments of the present disclosure.

Refer to FIG. 4, which illustrates a structural block diagram of a system for speech recognition according to one embodiment of the present disclosure. The system specifically may include:

a first interception module 402 for intercepting a first speech segment from a monitored speech signal and analyzing the first speech segment to determine an energy spectrum; a characteristic extracting module 404 for extracting characteristics of the first speech segment according to the energy spectrum and determining speech characteristics; a second interception module 406 for analyzing the energy spectrum of the first speech segment according to the speech characteristics, and intercepting a second speech; and a speech recognition module 408 for recognizing the speech of the second speech segment and obtaining a speech recognition result.

The speech recognition system according to the embodiment of the present disclosure can perform speech recognition and perform control by speech in the off-line state. First, the first interception module 402 monitors a speech signal to be recognized, and intercepts a first speech segment as a fundamental speech signal for subsequent speech processing; second, the characteristic extraction module 404 extracts characteristics from the first speech segment intercepted by the first interception module 402; third, the second interception module 406 intercepts the first speech segment for the second time to obtain a second speech segment; and finally, the speech recognition module 408 performs the speech recognition on the second speech segment to obtain a speech recognition result.

In conclusion, the system embodiment of the present disclosure is implemented according to the method embodiment of the present disclosure by the steps of intercepting a first speech segment from a monitored speech signal, analyzing the first speech segment to determine the energy spectrum, extracting characteristics of the first segment of speech signal according to the energy spectrum, intercepting the first speech segment according to the extracted speech characteristics to obtain more accurate second speech segment, and performing speech recognition on the second speech segment, and obtaining the speech recognition result. The present disclosure solves the problems of single speech recognition function and low recognition rate in the off-line state.

The system embodiment is basically the same as the method embodiments and therefore is simply described. Related contents can be seen in the related description of the method embodiments.

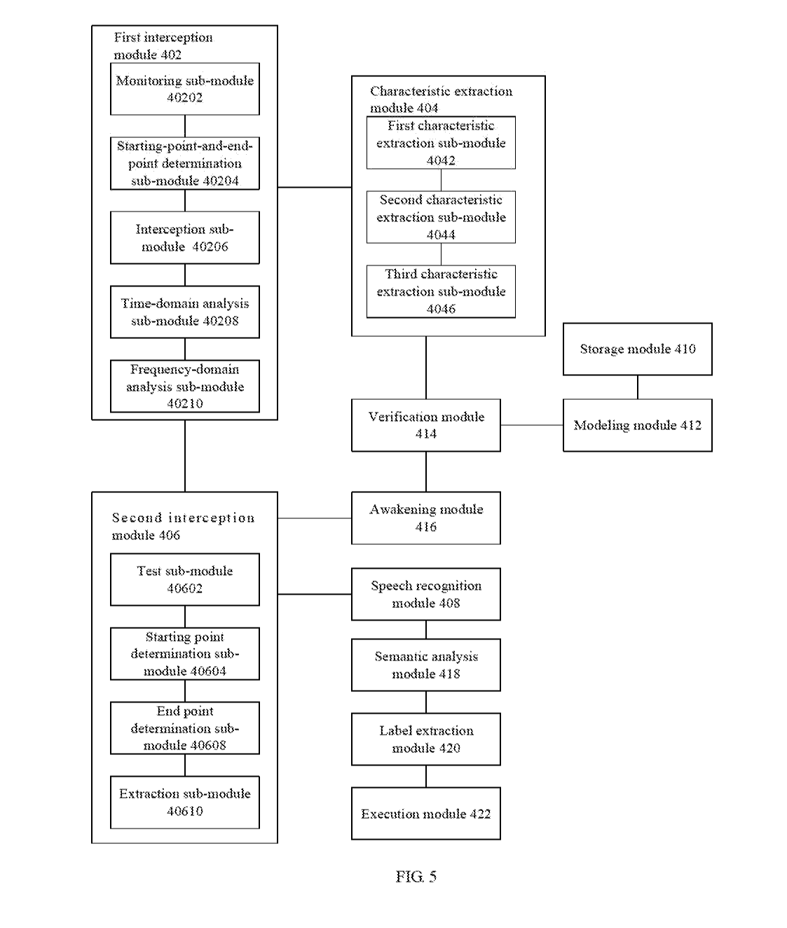

Refer to FIG. 5, which illustrates a structural block diagram of a first system for speech recognition according to another embodiment of the present disclosure. The system specifically may include:

a storage module 410 for pre-storing the user speech characteristics of each user; a modeling module 412 for constructing a user speech model according to the user speech characteristics of each user, wherein the user speech model is used for determining a user corresponding to a speech signal; a monitoring sub-module 40202 for monitoring a speech signal and testing an energy value of the monitored speech signal; a starting-point-and-end-point determination sub-module 40204 for determining a starting point and an end point of a speech signal according to the a first energy threshold and a second energy threshold, wherein the first energy threshold is greater than the second energy threshold an interception sub-module 40206 for intercepting the speech signal between the starting point and the end point as a first speech segment, a time-domain analysis sub-module 40208 for performing time-domain analysis on the first speech segment to obtain a time-domain signal of the first speech segment, a frequency-domain analysis sub-module 40210 for converting the time-domain signal into a frequency-domain signal and removing phase information in the frequency-domain signal; and an energy spectrum determination sub-module 40212 for converting the frequency-domain signal into an energy spectrum.

The system also includes: a first characteristic extraction sub-module 4042 for analyzing the energy spectrum according to the first speech segment on the basis of a first model, and extracting speech recognition characteristics, wherein the speech recognition characteristics include MFCC characteristic, PLP characteristic or LDA characteristic; a second characteristic extraction sub-module 4044 for analyzing the energy spectrum according to the first speech segment on the basis of a second model and extracting speaker speech characteristics, wherein the speaker speech characteristics include a high-order MFCC characteristic; and a third characteristic extraction sub-module 4046 for converting the energy spectrum corresponding to the first speech segment into a power spectrum, and analyzing the power spectrum to obtain the base frequency characteristics.

The system also includes: a test sub-module 40602 for testing the energy spectrum of the first speech segment on the basis of the third model according to the speech recognition characteristics and the base frequency characteristics, and determining a silent portion and a speech portion; a starting point determination sub-module 40604 for determining a starting point according to a first speech portion in the first speech segment; an end point determination sub-module 40608 for determining an end point according a speech portion prior to the silent portion when the time length of the silent portion exceeds a silent threshold; and an extraction sub-module 40610 for extracting speech signals between the starting point and the end point and generating a second speech segment.

The system also includes: a verification module 414 for inputting the speaker speech characteristics and the base frequency characteristics into the user speech model to perform speaker verification; and awakening module 416 for extracting awakening information from the second speech segment when the speaker verification result is accepted, wherein the awakening information includes awakening words or awakening intention information; a semantic analysis module 418 for performing semantic analysis match on the speech recognition result by using a preset semantic rule, wherein the semantic analysis match includes at least one of precise match, semantic element match and fuzzy match; a label extraction module 420 for analyzing the scene of the semantic analysis result and extracting at least one semantic label; and an execution module 422 for determining an operation command according to a semantic label and executing the operation command.

In conclusion, the system embodiment of the present disclosure is implemented according to the method embodiment of the present disclosure by the steps of intercepting a first speech segment from a monitored speech signal, analyzing the first speech segment to determine the energy spectrum, extracting characteristics of the first segment of speech signal according to the energy spectrum, namely extracting the speech recognition characteristic, speaker characteristic and base frequency characteristic respectively, intercepting the first speech segment according to the speech recognition characteristic and the base frequency characteristic to obtain more accurate second speech segment, determining the user, to which the speech segment belongs according to the speaker speech characteristic and the base frequency characteristic, presetting the awakening step, performing speech recognition on the second speech segment and obtaining the speech recognition result. The present disclosure solves the problems of single speech recognition function and low recognition rate in the off-line state.

The system embodiment described above is schematic, wherein units described as separable parts may be or may not be physically separated, and components displayed as units may be or may not be physical units, which means that the units can be positioned at one place or distributed on a plurality of network units. Some or all modules can be selected to fulfill the objective of the solution in the embodiment upon actual demands. Those ordinarily skilled in this field can understand and implement the present disclosure without creative work.

All embodiments of the present disclosures are described in a progressive manner. Every embodiment focuses on different factors. Identical and similar parts of the embodiments can be reference of one another.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

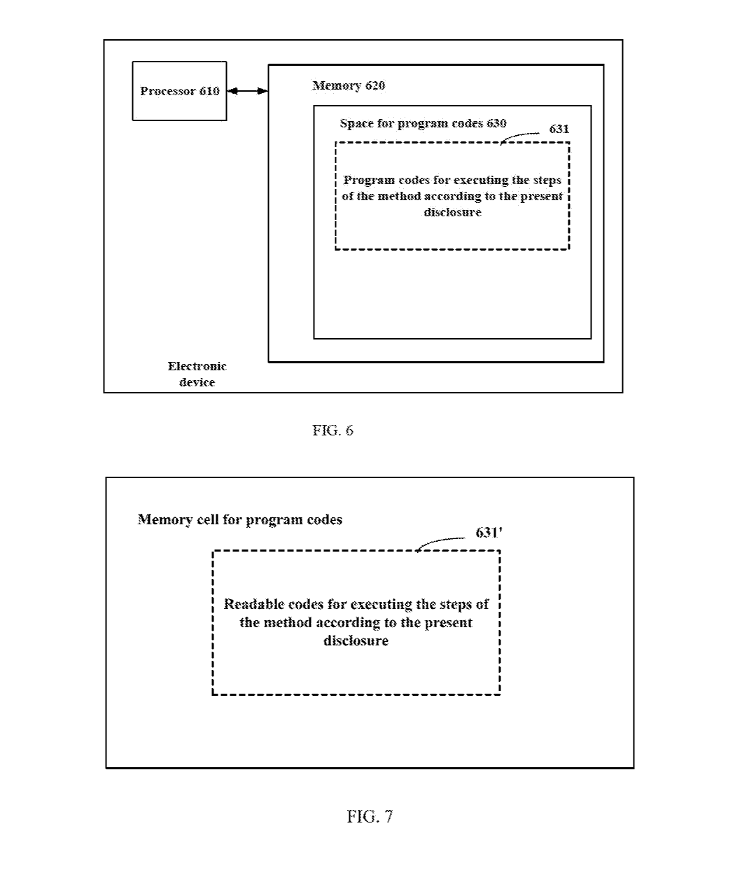

For example, FIG. 6 illustrates a block diagram of an electronic device for executing the method according the disclosure, the electronic device may be the intelligent device above. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the electronic device as shown in FIG. 6. The program codes may be compressed for example in an appropriate form. Usually, the memory cell includes computer readable codes 631′ which can be read for example by processors 610. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are described with reference to the flow charts and/or block diagrams of the methods and terminal devices (system) and computer program products of the embodiments of the present disclosure. It should be understood that the computer program commands realize every process and/or block in the flow charts and/or block diagrams and the combination of processes and/or blocks in the flow charts and/or block diagrams. The computer program command can be supplied to the processor of a universal computer, a special computer, an embedded processing machine or other programmable data processing terminals device to generate a machine, so the commands executed by the processor of the computer or other programmable data processing terminals generate a device for realizing specific functions in one or more processes in the flow charts and/or one or more blocks in the block diagrams.

The computer program commands can also be stored in computer readable memories which guide the computer or other data processing terminal devices to work in a specific mode, so the commands stored in the computer readable memories generate products including command devices, and the command devices conduct specific functions in one or more processes in the flow charts and/or one or more blocks in the block diagrams.

The computer program commands can also be loaded in the computer or other programmable data processing terminal devices such that computer or other programmable data processing terminal devices execute a series of operations to generate processing executed by the computer. Thus, the commands executed in the computer or other programmable data processing terminal devices supply steps of conducting specific functions in one or more processes in the flow charts and/or one or more blocks in the block diagrams.

The present disclosure describes the speech recognition method and the speech recognition system in detail. In the text, specific examples are used to describe the principle and implementation modes of the present disclosure. The above embodiments are used to describe instead of limiting the technical solution of the present disclosure; although the above embodiments describe the present disclosure in detail, those ordinarily skilled in this field shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment. Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for speech recognition, comprising:
at an electronic device;
intercepting a first speech segment from a monitored speech signal, and analyzing the first speech segment to determine an energy spectrum;
extracting characteristics of the first speech segment according to the energy spectrum, and determining speech characteristics;
analyzing the energy spectrum of the first speech segment according to the speech characteristics, and intercepting a second speech segment;
recognizing the speech of the second speech segment and obtaining a speech recognition result.

2. The method according to claim 1, wherein intercepting the first speech segment from the monitored speech signal comprises:
monitoring the speech signal, testing the energy value of the monitored speech signal;
determining a starting point and an end point of the speech signal according to a first energy threshold and a second threshold; wherein the first energy threshold is greater than the second energy threshold;
taking the speech signal between the starting point and the end point as the first speech segment.

3. The method according to claim 1, wherein extracting characteristics of the first speech segment according to the energy spectrum and determining speech characteristics comprises:
analyzing the energy spectrum corresponding to the first speech segment on the basis of a first model, and extracting speech recognition characteristics, wherein the speech recognition characteristics include MFCC characteristic, PLP characteristic or LDA characteristic;
analyzing the energy spectrum according to the first speech segment on the basis of a second model, and extracting speaker speech characteristics, wherein the speaker speech characteristics include a high-order MFCC characteristic;
converting the energy spectrum corresponding to the first speech segment into a power spectrum, and analyzing the power spectrum to obtain the base frequency characteristics.

4. The method according to claim 1, wherein analyzing the energy spectrum of the first speech segment according to the speech characteristics and intercepting a second speech segment comprises:
testing the energy spectrum of the first speech segment on the basis of the third model according to the speech recognition characteristics and the base frequency characteristics, determining a silent portion and a speech portion;
determining a starting point according to a first speech portion in the first speech segment;
when the time length of the silent portion exceeds a silent threshold, determining an end point of a speech portion prior to the silent portion;
extracting speech signals between the starting point and the end point, and generating a second speech segment.

5. The method according to claim 1, wherein the method further comprises:
storing user speech characteristics of each user in advance;
constructing a user speech model according to the user speech characteristics of every user, wherein the user speech model is used for determining a user corresponding to a speech signal.

6. The method according to claim 5, wherein before recognizing the speech of the second speech segment and obtaining a speech recognition result, the method further comprises:
inputting the speaker speech characteristic and the base frequency characteristic into the user speech model to verify the speaker;
and extracting awakening information from the second speech segment when the speaker verification is accepted, wherein the awakening information includes awakening words or awakening intention information.

7. The method according to claim 1, wherein after obtaining the speech recognition result, the method further comprises:
performing semantic analysis match on the speech recognition result by using a preset semantic rule, wherein the semantic analysis match includes at least one of precise match, semantic element match and fuzzy match;
analyzing the scene of the semantic analysis result, and extracting at least one semantic label;
determining an operation command according to the semantic label and executing the operation command.

8. An electronic device for speech recognition comprising:
at least one processor, and
a memory communicably connected with the at least one processor for storing instructions executable by the at least one processor, wherein execution of the instructions by the at least one processor causes the at least one processor to:
intercept a first speech segment from a monitored speech signal and analyze the first speech segment to determine an energy spectrum;
extract characteristics of the first speech segment according to the energy spectrum and determining speech characteristics;
analyze the energy spectrum of the first speech segment according to the speech characteristics and intercept a second speech segment;
recognize the speech of the second speech segment and obtain a speech recognition result.

9. The electronic device according to claim 8, wherein intercept a first speech segment from a monitored speech signal and analyze the first speech segment to determine an energy spectrum comprises:
monitor the speech signal, testing the energy value of the monitored speech signal;
determine a starting point and an end point of the speech signal according to a first energy threshold and a second threshold; wherein the first energy threshold is greater than the second energy threshold;
take the speech signal between the starting point and the end point as the first speech segment.

10. The electronic device according to claim 8, wherein extract characteristics of the first speech segment according to the energy spectrum and determining speech characteristics comprises:
analyze the energy spectrum corresponding to the first speech segment on the basis of a first model, and extract speech recognition characteristics, wherein the speech recognition characteristics include MFCC characteristic, PLP characteristic or LDA characteristic;
analyze the energy spectrum according to the first speech segment on the basis of a second model, and extract speaker speech characteristics, wherein the speaker speech characteristics include a high-order MFCC characteristic;
convert the energy spectrum corresponding to the first speech segment into a power spectrum, and analyze the power spectrum to obtain the base frequency characteristics.

11. The electronic device according to claim 8, wherein analyze the energy spectrum of the first speech segment according to the speech characteristics and intercept a second speech segment comprises:
test the energy spectrum of the first speech segment on the basis of the third model according to the speech recognition characteristics and the base frequency characteristics, determine a silent portion and a speech portion;
determine a starting point according to a first speech portion in the first speech segment;
determine an end point of a speech portion prior to the silent portion when the time length of the silent portion exceeds a silent threshold;
extract speech signals between the starting point and the end point, and generate a second speech segment.

12. The electronic device according to claim 8, wherein execution of the instructions by the at least one processor causes the at least one processor to further:
store user speech characteristics of each user in advance;
construct a speaker speech model according to the user speech characteristics of every user, wherein the user speech model is used for determining a user corresponding to a speech signal.

13. The electronic device according to claim 8, wherein execution of the instructions by the at least one processor causes the at least one processor to further:
perform semantic analysis match on the speech recognition result by using a preset semantic rule, wherein the semantic analysis match includes at least one of precise match, semantic element match and fuzzy match;
analyze the scene of the semantic analysis result, and extract at least one semantic label;
determine an operation command according to the semantic label and executing the operation command.

14. A non-transitory computer readable medium, storing executable instructions that, when executed by an electronic device, cause the electronic device to:
intercept a first speech segment from a monitored speech signal, analyze the first speech segment to determine an energy spectrum;
extract characteristics of the first speech segment according to the energy spectrum, determine speech characteristics;
analyze the energy spectrum of the first speech segment according to the speech characteristics, intercept a second speech segment;
recognize the speech of the second speech segment and obtain a speech recognition result.

15. The non-transitory computer readable medium according to claim 14, wherein intercept the first speech segment from the monitored speech signal comprises:
monitoring the speech signal testing the energy value of the monitored speech signal;
determining a starting point and an end point of the speech signal according to a first energy threshold and a second threshold; wherein the first energy threshold is greater than the second energy threshold;
taking the speech signal between the starting point and the end point as the first speech segment.

16. The non-transitory computer readable medium according to claim 14, wherein extract characteristics of the first speech segment according to the energy spectrum and determine speech characteristics comprises:
analyzing the energy spectrum corresponding to the first speech segment on the basis of a first model, and extracting speech recognition characteristics, wherein the speech recognition characteristics include MFCC characteristic, PLP characteristic or LDA characteristic;
analyzing the energy spectrum according to the first speech segment on the basis of a second model, and extracting speaker speech characteristics, wherein the speaker speech characteristics include a high-order MFCC characteristic;
converting the energy spectrum corresponding to the first speech segment into a power spectrum, and analyzing the power spectrum to obtain the base frequency characteristics.

17. The non-transitory computer readable medium according to claim 14, wherein analyze the energy spectrum of the first speech segment according to the speech characteristics and intercept a second speech segment comprises:
testing the energy spectrum of the first speech segment on the basis of the third model according to the speech recognition characteristics and the base frequency characteristics, determining a silent portion and a speech portion;
determining a starting point according to a first speech portion in the first speech segment;
when the time length of the silent portion exceeds a silent threshold, determining an end point of a speech portion prior to the silent portion;
extracting speech signals between the starting point and the end point, and generating a second speech segment.

18. The non-transitory computer readable medium according to claim 14, wherein the electronic device is further caused to:
store user speech characteristics of each user in advance;
construct a user speech model according to the user speech characteristics of every user, wherein the user speech model is used for determining a user corresponding to a speech signal.

19. The non-transitory computer readable medium according to claim 18, wherein before recognize the speech of the second speech segment and obtain a speech recognition result, the electronic device is further caused to:
input the speaker speech characteristic and the base frequency characteristic into the user speech model to verify the speaker; and
extract awakening information from the second speech segment when the speaker verification is accepted, wherein the awakening information includes awakening words or awakening intention information.

20. The non-transitory computer readable medium according to claim 14, wherein after obtain the speech recognition result, the electronic device is further caused to:
perform semantic analysis match on the speech recognition result by using a preset semantic rule, wherein the semantic analysis match includes at least one of precise match, semantic element match and fuzzy match;
analyze the scene of the semantic analysis result, and extract at least one semantic label;
determine an operation command according to the semantic label and executing the operation command.
